(19) United States
(12) Patent Application Publication
(10) Pub. No.: US 2014/0106886 A1
(43) Pub. Date: Apr. 17, 2014

(54) Method of Operating a Cheering Application with a Mobile Computing Device

(71) Applicant: Elizabeth Renee PROCHNOW, Hermosa Beach, CA (US)

(72) Inventor: Elizabeth Renee PROCHNOW, Hermosa Beach, CA (US)

(21) Appl. No.: 14/053,415

(22) Filed: Oct. 14, 2013

Related U.S. Application Data
(60) Provisional application No. 61/713,071, filed on Oct. 12, 2012.

(51) Int. Cl. A63F 13/00

(52) U.S. Cl. CPC A63F 13/00
USPC 463/35

(57) ABSTRACT

A cheering application, which is downloaded into a mobile computing device, can be activated through a user's motion so that the cheering application can simulate the “Defense” chant commonly heard at American football games. A default image within the application is colored through a color wheel, where the color wheel allows the users to select desired colors for the foreground and the background of the default image. The default image with the desired colors is displayed through the mobile computing device, where the default image is converted into four different images. Each of the four images is combined with a respective audio clip so that the audio clip can also be played through the mobile computing device. The four images and the respective audio clips are displayed and played through the mobile computing device as long as the user continues his or her motion.

The current application claims a priority to the U.S. Provisional Patent application Ser. No. 61/713,071 filed on Oct. 12, 2012.

### FIELD OF THE INVENTION

The present invention relates generally to a mobile device application. Specifically, the present invention is a mobile device application that simulates the “Defense” chant commonly heard at American football games. The application utilizes the accelerometer and gyroscope technologies commonly found in mobile devices to initiate the chant mechanism based on user motions. The application appearance is customizable to the user's preferences as well.

### BACKGROUND OF THE INVENTION

Crowd participation is an important aspect of many competitive sports. Vocal participation in sports such as American football can have an impact on the mental and physical performance of the players on the field. Crowd noise can boost the morale of a home team while simultaneously demoralizing the opposing team. Vocal participation as part of a large group also enhances the experience of attending a sports game. A common chant often heard at American football games is the “Defense” chant. A home crowd chants “defense” and claps hands to generate noise when the opposing team is in possession of the football. The present invention seeks to improve the game day social experience of sports fans.

It is therefore the object of the present invention to provide a means of greater vocal participation during sporting events. The present invention is a mobile device application that simulates the common “Defense” chant often heard at American football games. The application is engaged by user motion activated accelerometer and gyroscope technology within mobile devices. A “pumping” motion by a user holding a mobile device displays the letter “D” and an image of a picket fence on the display screen of the mobile device. The application also plays a recorded “Defense” chant according to the “pumping” motions of the user. The images displayed on the screen and the recorded “Defense” chants correspond to the claps and vocalized chants of spectators during a sporting event. Users are able to customize the colors of the images displayed on the screen of the mobile device to their preferences.

### BRIEF DESCRIPTION OF THE DRAWINGS

FIG. 1 is a basic flowchart illustrating the overall method of the present invention.

FIG. 2 is a basic flowchart illustrating the chant feature of the present invention.

FIG. 3 is a basic flowchart illustrating the method of selecting the first desired color and the second desired color of the present invention.

FIG. 4 is a basic flowchart illustrating the method of displaying the first image and playing the first audio clip of the present invention.

FIG. 5 is a basic flowchart illustrating the method of displaying the second image and playing the second audio clip of the present invention.

FIG. 6 is a basic flowchart illustrating the method of displaying the third image and playing the third audio clip of the present invention.

FIG. 7 is a basic flowchart illustrating the method of displaying the fourth image and playing the fourth audio clip of the present invention.

FIG. 8 is a basic flowchart illustrating the information feature of the present invention.

FIG. 9 is a view showing the color wheel and the default image of the preferred embodiment.

FIG. 10 is a view showing the first motion of the animated person within the chant feature of the preferred embodiment.

FIG. 11 is a view showing the second motion of the animated person within the chant feature of the preferred embodiment.

FIG. 12 is a view showing the first image of the preferred embodiment.

FIG. 13 is a view showing the second image of the preferred embodiment.

FIG. 14 is a view showing the third image of the preferred embodiment.

FIG. 15 is a view showing the fourth image of the preferred embodiment.

### DETAIL DESCRIPTIONS OF THE INVENTION

All illustrations of the drawings are for the purpose of describing selected versions of the present invention and are not intended to limit the scope of the present invention.

The present invention is a method of operating a cheering application with a mobile computing device. The present invention utilizes an accelerometer and a gyroscope of the mobile computing device to initiate the cheering application based on the physical actions of a user. Once the cheering application is downloaded into the mobile computing device, the user can select the cheering application so that the cheering application can be activated through the operating system of the mobile computing device.

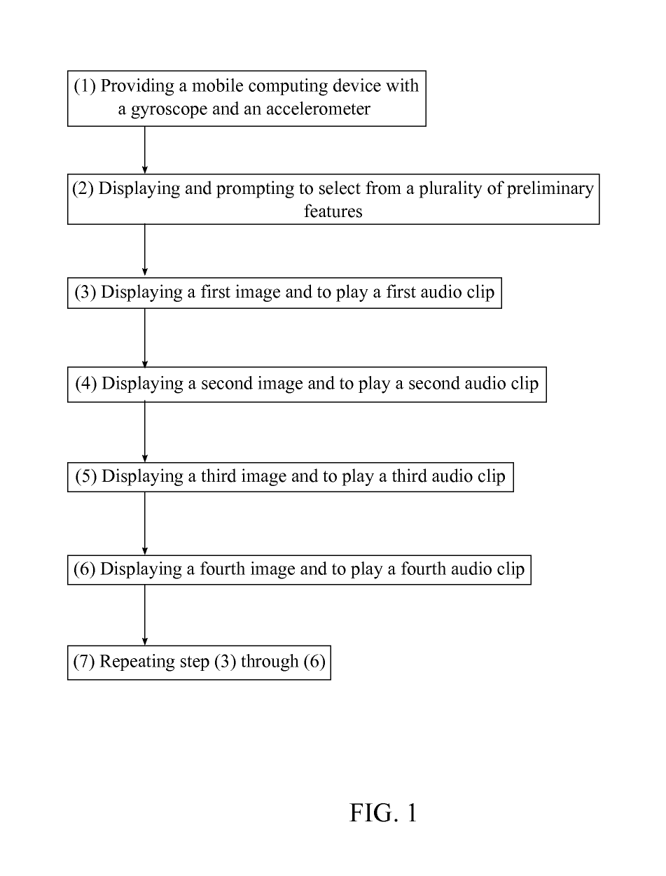

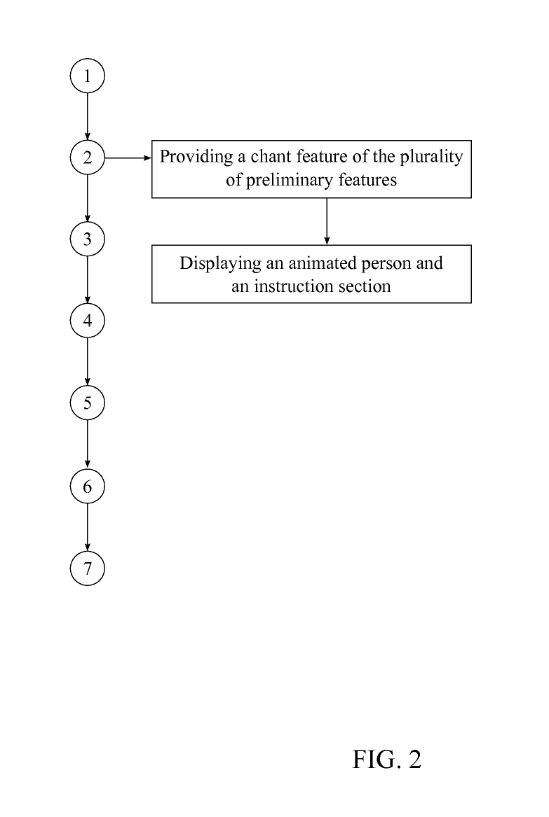

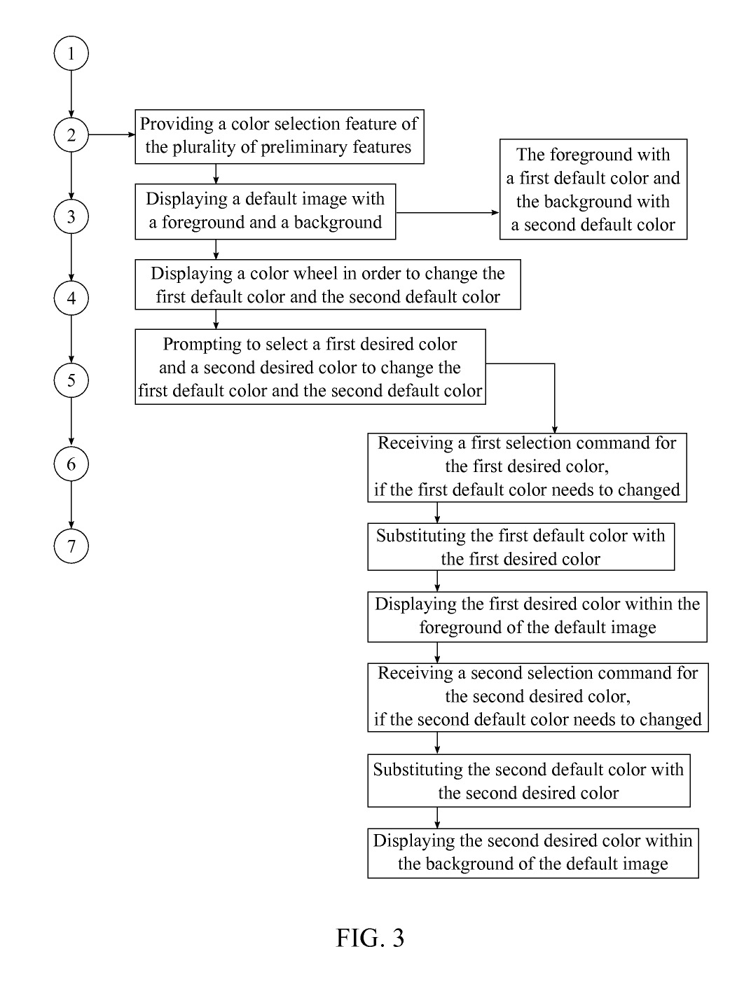

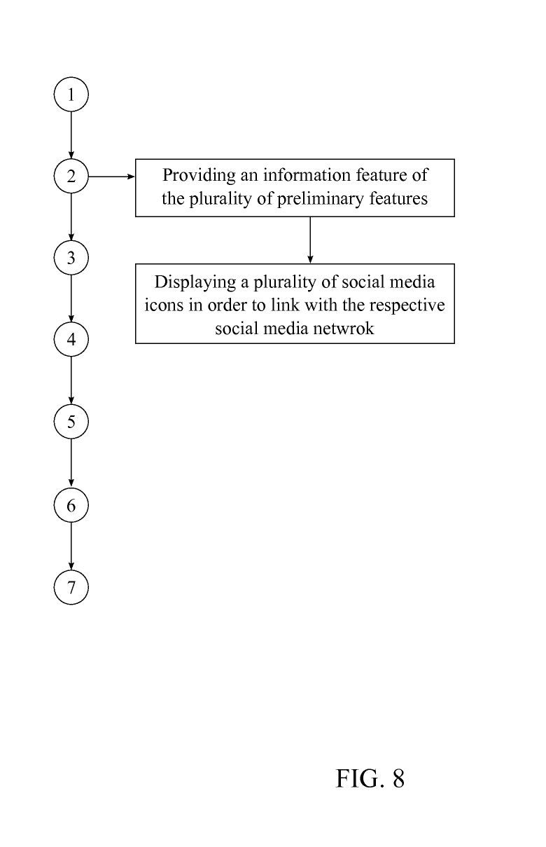

In reference to FIG. 1, FIG. 2, FIG. 3, and FIG. 8, once the cheering application is selected by the user, the control software displays a plurality of preliminary features to the user, where each of the preliminary features provides a different functionality with the cheering application. A chanting function, which is a direct output of the physical action of the user, functions independently from the plurality of preliminary features and can be initiated anytime as the user desired.

In reference to FIG. 2, the plurality of preliminary features includes a chant feature which provides an instruction section on how to use the cheering application as well as animated person showing the required physical motion performed by the user during the chanting function. More specifically, the chant feature explains the appropriate method of hold the mobile computing device and proper method of moving the mobile computing device so that the cheering application can be efficiently utilized by the user. The displayed instruction section and the required physical motion of the animated person, which is similar to a pumping motion, serve as a guide to the user. The displayed instruction section and the animated person instruct the user to hold the mobile computing device in his or her hand with the display screen of the mobile computing device facing away from his or her body and to extend his or her arm away from the body and then back towards the body in the pumping motion. The pumping motion of the user engages the accelerometer and gyroscope technologies within the mobile computing device to initiate the chanting function of the cheering application. Prior to using the chanting function, the audio volume of the mobile computing device needs to be maximized so that the volume can be a factor for the present invention.

In reference to FIG. 3, the plurality of preliminary features further includes a color selection feature, where the control software displays a default image to the user, where the default image includes a foreground and a background. The foreground of the default image is colored with a first default color, preferably the white color. The background of the default image is colored with a second default color, preferably the black color. Along with the default image, the control software simultaneously displays a color wheel to the user so that the user can change the first default color and the second default color if he or she desires. The color wheel is completed with primary colors, secondary colors, and complementary colors in such way that the user is able to find any different color. The control software then prompts the user to select a first desired color and a second desired color in order to change the first default color and the second default color respectively. More specifically, the control software prompts the user to select the first desired color from the color wheel in order to change the first default color only if the user desires. When the control software receives a first selection command for the first desired color, the first default color is substituted with the first desired color. The first desired color only colors the foreground of the default image as the first desired color is displayed within the foreground of the default image. At the same time, the control software prompts the user to select the second desired color from the color wheel in order to change the second default color only if the user desires. When the control software receives a second selection command for the second desired color, the second default color is substituted with the second desired color. The second desired color only colors the background of the default image as the second desired color is displayed within the background of the default image. The selection of the first desired color and the second desired color are completely independent from one another where one does not precede the other.

When the user selects the first desired color and the second desired color, the default image is displayed below the color wheel in such way that default image functions as a preview image and changes to reflect the user's chose of the first desired color and the second desired color. For example, if the user selects the gold color as the first desired color, the control software substitutes the first default color with the gold color and displays the gold color within the foreground of the default image. If the user selects the burgundy color as the second desired color, the control software substitutes the second default color with the burgundy color and displays the burgundy color within the background of the default image. The first desired color and the second desired color preview within the default image until the user decides to change them into different colors.

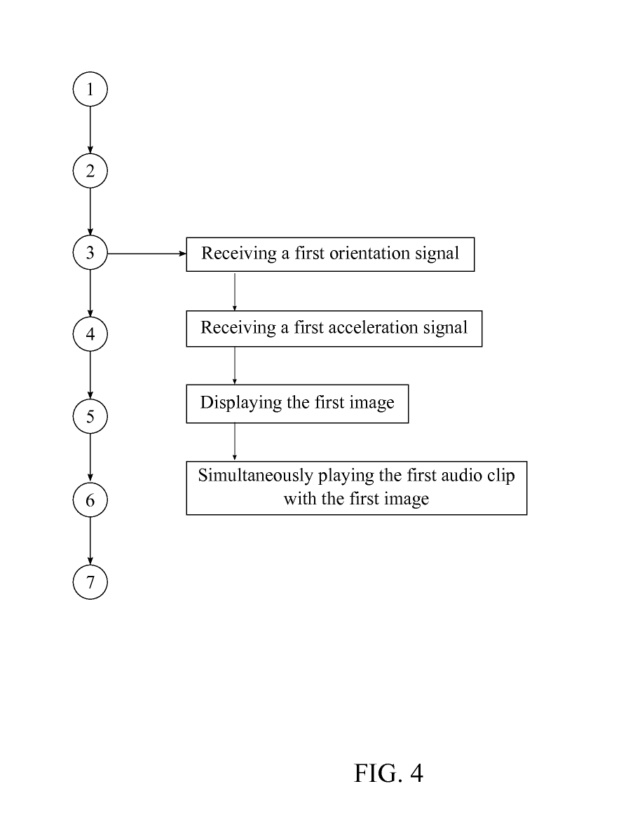

In reference to FIG. 1 and FIG. 4, the control software displays a first image and to play a first audio clip as result of the chanting function. In order to display the first image and to play the first audio clip, the user needs to move the mobile computing device in the pumping motion imitating the animation person of the chant feature. Then the control software receives a first orientation signal from the gyroscope as the user holds the display screen facing away from the his or her body, where the first orientation signal measures and maintains the orientation of the mobile computing device. At the same time, the control software receives a first acceleration signal from the accelerometer as the user extends his or her arm away from the body and then back towards the body in the pumping motion, where the first acceleration signal measures the linear acceleration of the mobile computing device. Then the control software displays the first image through the display screen of the mobile computing device while playing the first audio clip through the speakers of the mobile computing device. The first image of the present invention is similar to the default image, but the first image is colored with the first desired color and the second desired color. The foreground and the background of the first image are also larger than the foreground and the background of the default image.

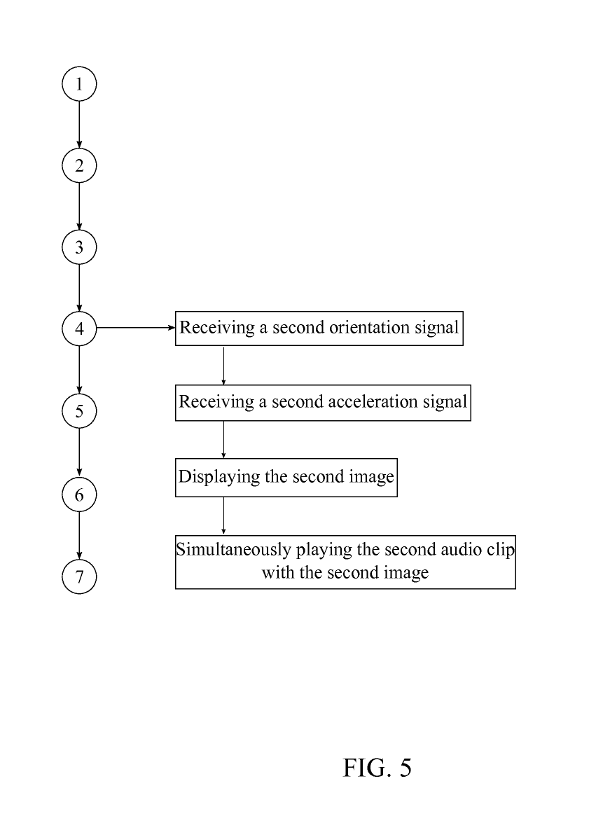

In reference to FIG. 1 and FIG. 5, the control software displays a second image and to play a second audio clip as result of the chanting function. In order to display the second image and to play the second audio clip, the user needs to move the mobile computing device in the pumping motion after the initial pumping motion which displays the first image and plays the first audio clip. Then the control software receives a second orientation signal from the gyroscope as the user continue to holds the display screen facing away from the his or her body, where the second orientation signal measures and maintains the orientation of the mobile computing device. Since the second orientation signal follows the first orientation signal, the control software is able to distinguish them apart within the cheering application. At the same time, the control software receives a second acceleration signal from the accelerometer as the user extends his or her arm away from the body and then back towards the body in the pumping motion, where the second acceleration signal measures the linear acceleration of the mobile computing device. Since the second acceleration signal follows the first acceleration signal, the control software can easily identify them apart within the cheering application. Then the control software displays the second image through the display screen of the mobile computing device while playing the second audio clip through the speakers of the mobile computing device. The second image of the present invention is similar to the default image, but the second image is colored with the first desired color and the second desired color. The foreground of the second image is also larger than the foreground of the first image.

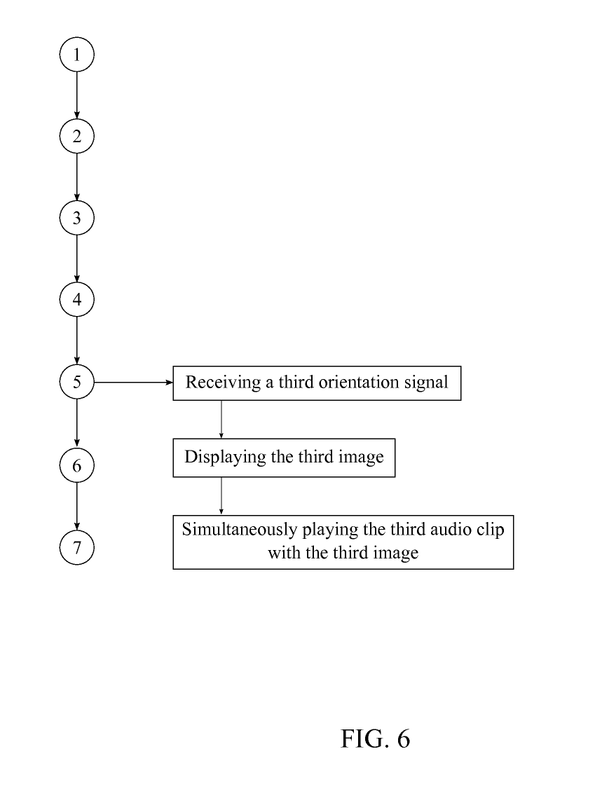

In reference to FIG. 1 and FIG. 6, the control software displays a third image and to play a third audio clip as result of the chanting function. In order to display the third image and to play the third audio clip, the user does not need to move the mobile computing device in the pumping motion. Then the control software receives a third orientation signal from the gyroscope as the user continue to holds the display screen facing away from the his or her body, where the third orientation signal measures and maintains the orientation of the mobile computing device. Then the control software displays the third image through the display screen of the mobile computing device while playing the third audio clip through the speakers of the mobile computing device. The third image of the present invention is partially similar to the default image, but only a first portion of the default image is enlarged and displayed with the first desired color and the second desired color.

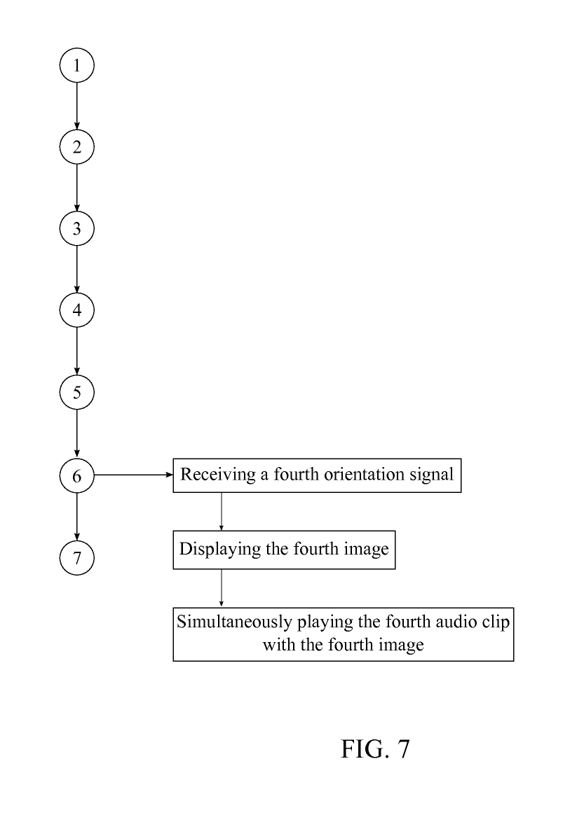

In reference to FIG. 1 and FIG. 7, the control software displays a fourth image and to play a fourth audio clip as result of the chanting function. In order to display the fourth image and to play the fourth audio clip, the user does not need to move the mobile computing device in the pumping motion. Then the control software receives a fourth orientation signal from the gyroscope as the user continue to holds the display screen facing away from the his or her body, where the fourth orientation signal measures and maintains the orientation of the mobile computing device. Since the fourth orientation signal follows the third orientation signal, the control software is able to recognize them apart within the cheering application. Then the control software displays the fourth image through the display screen of the mobile computing device while playing the fourth audio clip through the speakers of the mobile computing device. The fourth image of the present invention is partially similar to the default image, but only a second portion of the default image is enlarged and displayed with the first desired color and the second desired color.

In reference to FIG. 1, the sequences from displaying the first image and playing the first audio clip to displaying the fourth image and playing the fourth audio clip of the chanting function are then repeated as long as the user is able provides the necessary physical motions described above. For example, when the user activates the first orientation signal and the first acceleration signal for the second time after the fourth orientation signal, the cheering application displays the first image and plays the first audio clip following the fourth image and the fourth audio clip. If the user does not provide the necessary physical motions after the fourth image and the fourth audio clip, the present invention comes to a halt. In order to maximize the viewing area for the first, second, third, and fourth image of the present invention, the images are displayed in landscape mode of the mobile computing device.

In reference to FIG. 8, the plurality of preliminary features further includes an information feature which displays an overall concept of the cheering application and a plurality of social media icons that are link with the respective social media networks. The users can access the respective social media network by selecting each of the social media icons.

The chanting function of the cheering application can be initiated by the users anytime as long as the user is able to provide the necessary physical motions, where the chanting function is completely independent from the color selection feature, the chant feature and the information feature.

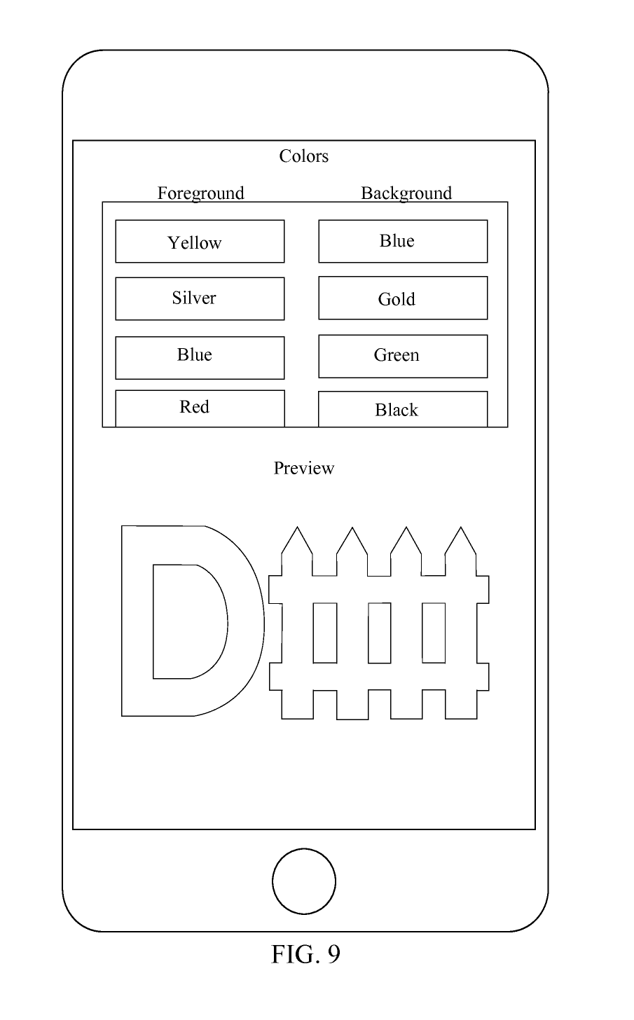

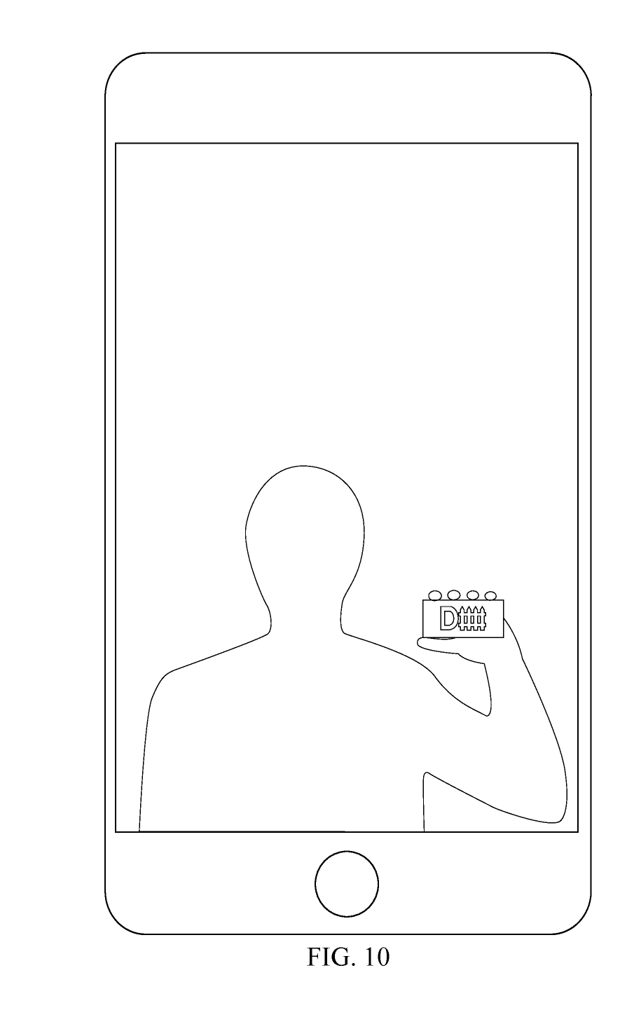

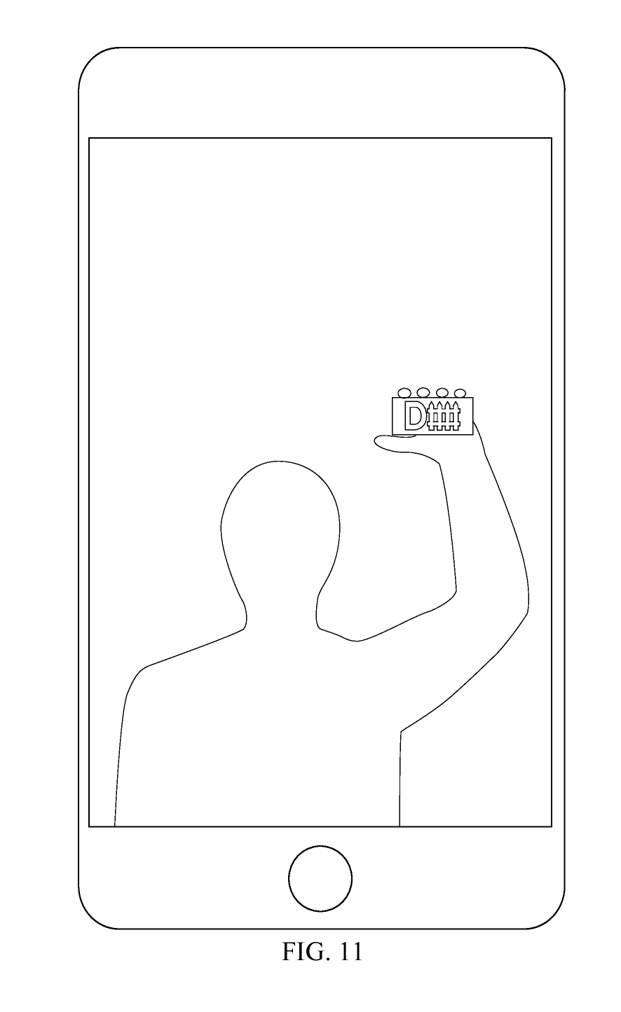

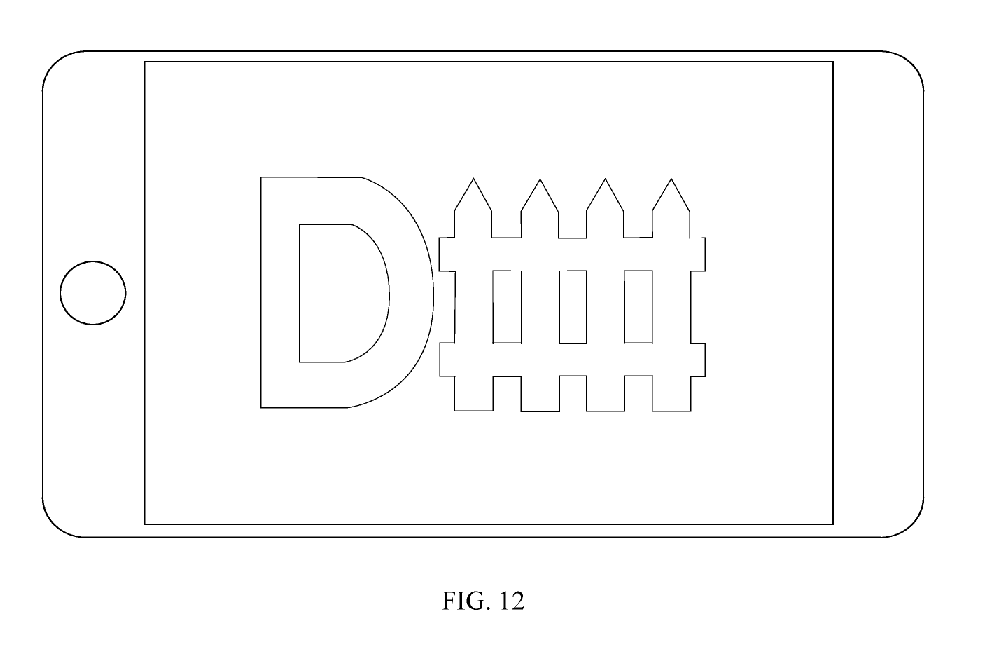

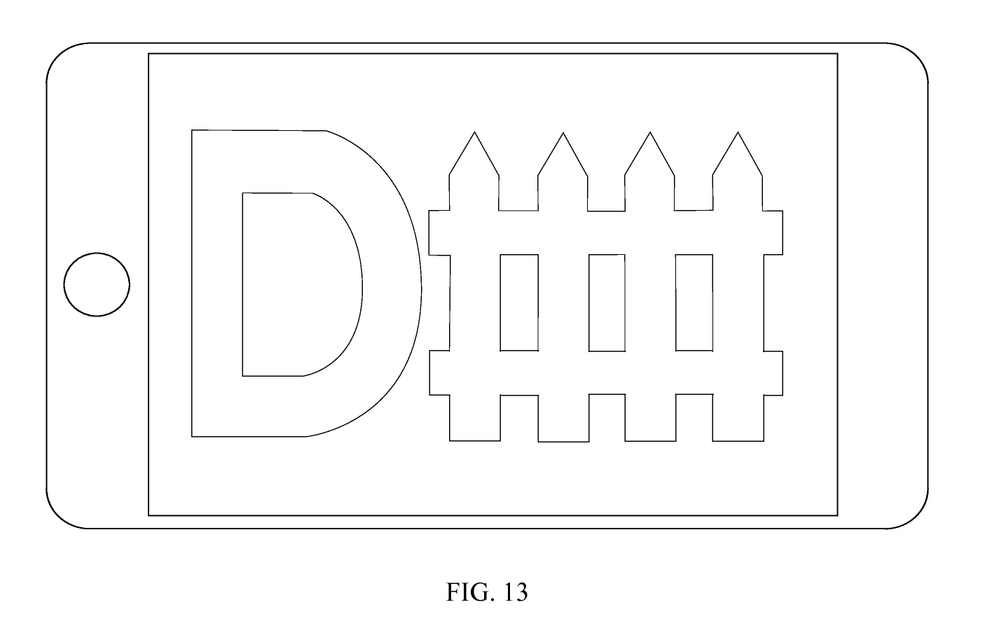

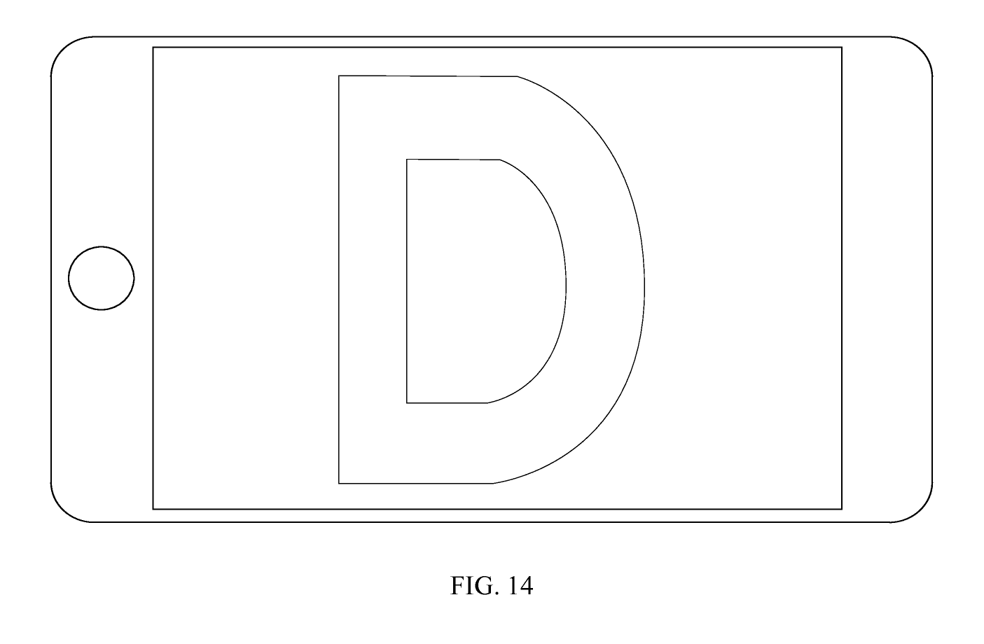

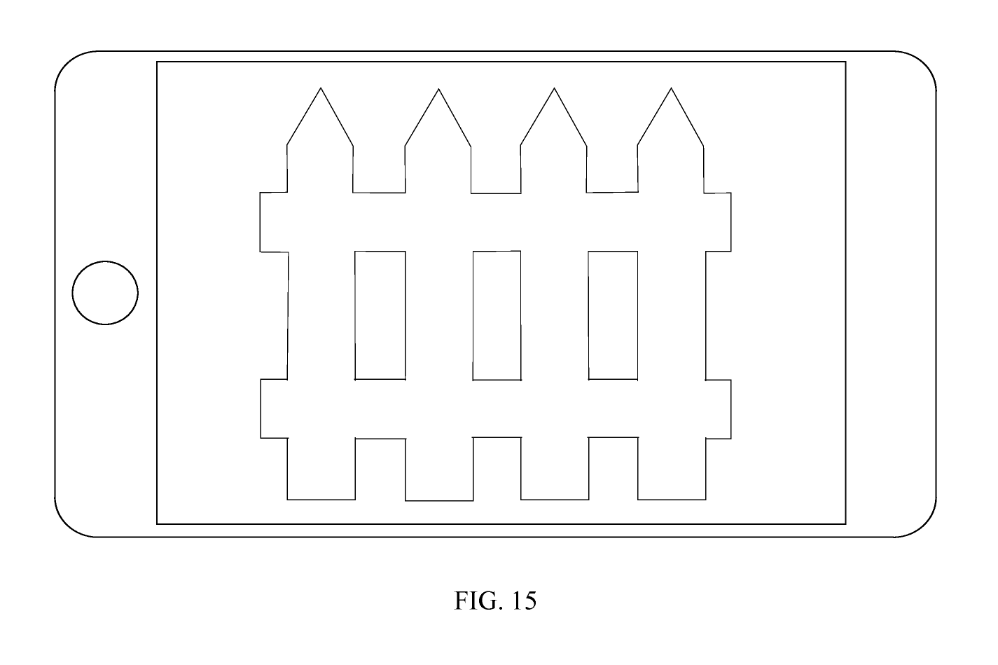

In a preferred embodiment of the present invention, the preferred embodiment simulates the defense-chant commonly heard in sport stadiums. The defense-chant is normally chanted with a picture of letter “D” and a picture of picket fence, where the picture of letter “D” is adjacently displayed with the picture of picket fence. The first syllable of the word “defense” corresponds to the picture of letter “D”, and the second syllable of the word “defense” corresponds to the picture of picket fence. After the pronunciation of the word “defense”, the defense-chant is followed with two clapping motions or two sound clips. The preferred embodiment follows the same process so that the defense-chant can be executed through the mobile computing device. In reference to FIG. 9, the default image of the preferred embodiment includes a letter “D” and a picket fence, where the letter “D” is the first portion and the picket fence is the second portion. When the default image is displayed within the display screen, the letter “D” and the picket fence are considered as the foreground and the rest of the display screen is considered as the background. The user can initiate the chanting function of the preferred embodiment with either the first default color and the second default color or the first desired color and the second desired color. For example, the user can either personalize the appearance of the foreground and the background of the default image through the color wheel according to his or her favorite sport team colors or keeps the first default color and second default color. In reference to FIG. 10 and FIG. 11, when the user holds the display screen facing away from the his or her body and extends his or her arm away from the body and then back towards the body in the pumping motion, the control software displays the first image and to plays the first audio clip. As shown in FIG. 12, the first image of the preferred embodiment includes the letter “D” and the picket fence and the first audio clip is the first clapping sound of the defense-chant. If the first desired color and the second desired color are selected through the color wheel, the first image is displayed with the first desired color and the second desired color; otherwise the first and second default colors are displayed within the first image. In reference to FIG. 11, when the user continue to holds the display screen facing away from the his or her body and extends his or her arm away from the body and then back towards the body in the pumping motion for the second time, the control software displays the second image and plays the second audio clip. More specifically, the second image of the preferred embodiment, which is shown in FIG. 13, includes the letter “D” and the picket fence with the first desired color and the second desired color, and the second audio clip is the second clapping sound of the defense-chant. Even though the first image and the second image are somewhat similar, the foreground of the second image is slightly enlarged compare to the foreground of the first image so that the first image and the second image can be differentiated from one another. The second audio clip is the second clapping sound of the defense-chant. If the first desired color and the second desired color are selected through the color wheel, the second image is displayed with the first desired color and the second desired color; otherwise the first and second default colors are displayed within the second image. In reference to FIG. 14, immediately following the second image and the second audio clip, the control software displays the third image and plays the third audio clip as long as the user continue to holds the display screen facing away from the his or her body. More specifically, the third image of the preferred embodiment includes the letter “D”, and the third audio clip is the pronunciation of the first syllable of the word “defense”. If the first desired color and the second desired color are selected through the color wheel, the third image is displayed with the first desired color and the second desired color; otherwise the first and second default colors are displayed within the third image. In reference to FIG. 15, immediately following the third image and the third audio clip, the control software displays the fourth image and plays the fourth audio clip as long as the user continue to holds the display screen facing away from the his or her body. More specifically, the fourth image of the preferred embodiment includes the picket fence, and the fourth audio clip is the pronunciation of the second syllable of the word “defense”. If the first desired color and the second desired color are selected through the color wheel, the fourth image is displayed with the first desired color and the second desired color; otherwise the first and second default colors are displayed within the fourth image.

Although the invention has been explained in relation to its preferred embodiment, it is to be understood that many other possible modifications and variations can be made without departing from the spirit and scope of the invention as hereinafter claimed.

What is claimed is:

1. A method of operating a cheering application with a mobile computing device by executing computer-executable instructions stored on a non-transitory computer-readable medium, the method comprises the steps of:
(1) providing a mobile computing device with a gyroscope and an accelerometer;
(2) displaying and prompting to select from a plurality of preliminary features;
(3) displaying a first image and to play a first audio clip;
(4) displaying a second image and to play a second audio clip;
(5) displaying a third image and to play a third audio clip;
(6) displaying a fourth image and to play a fourth audio clip; and
(7) repeating step (3) through (6).

2. The method of operating a cheering application with a mobile computing device by executing computer-executable instructions stored on a non-transitory computer-readable medium, the method as claimed in claim 1 comprises the steps of:
providing a chant feature of the plurality of preliminary features; and
displaying an animated person and an instruction section, wherein the animated person and the instruction section serve as a guide.

3. The method of operating a cheering application with a mobile computing device by executing computer-executable instructions stored on a non-transitory computer-readable medium, the method as claimed in claim 1 comprises the steps of:
providing a color selection feature of the plurality of preliminary features;
displaying a default image with a foreground and a background, wherein the foreground is colored with a first default color and the background is colored with a second default color;
simultaneously displaying a color wheel with the default image in order to change the first default color and the second default color; and
prompting to select a first desired color and a second desired color in order to change the first default color and the second default color respectively.

4. The method of operating a cheering application with a mobile computing device by executing computer-executable instructions stored on a non-transitory computer-readable medium, the method as claimed in claim 3 comprises the steps of:
wherein the first default color being the white color; and
wherein the second default color being the black color.

5. The method of operating a cheering application with a mobile computing device by executing computer-executable instructions stored on a non-transitory computer-readable medium, the method as claimed in claim 3 comprises the steps of:
receiving a first selection command for the first desired color,
if the first default color needs to be changed;
substituting the first default color with the first desired color;
displaying the first desired color within the foreground of the default image;
receiving a second selection command for the second desired color,
if the second default color needs to be changed;
substituting the second default color with the second desired color; and
displaying the second desired color within the background of the default image.

6. The method of operating a cheering application with a mobile computing device by executing computer-executable instructions stored on a non-transitory computer-readable medium, the method as claimed in claim 1 comprises the steps of:
receiving a first orientation signal, wherein the first orientation signal measures and maintains the orientation of the mobile computing device through the gyroscope;
receiving a first acceleration signal, wherein the first acceleration signal measures the linear acceleration of the mobile computing device through the accelerometer;
displaying the first image; and
simultaneously playing the first audio clip with the first image.

7. The method of operating a cheering application with a mobile computing device by executing computer-executable instructions stored on a non-transitory computer-readable medium, the method as claimed in claim 6 comprises:
wherein the first image being the default image with the first desired color and the second desired color; and
wherein the foreground and the background of the first image being larger than the foreground of the default image.

8. The method of operating a cheering application with a mobile computing device by executing computer-executable instructions stored on a non-transitory computer-readable medium, the method as claimed in claim 1 comprises the steps of:
receiving a second orientation signal, wherein the second orientation signal measures and maintains the orientation of the mobile computing device through the gyroscope;
receiving a second acceleration signal, wherein the second acceleration signal measures the linear acceleration of the mobile computing device through the accelerometer;
displaying the second image; and
simultaneously playing the second audio clip with the second image.

9. The method of operating a cheering application with a mobile computing device by executing computer-executable instructions stored on a non-transitory computer-readable medium, the method as claimed in claim 8 comprises:
wherein the second image being the default image with the first desired color and the second desired color; and
wherein the foreground of the second image being larger than the foreground of the first image.

10. The method of operating a cheering application with a mobile computing device by executing computer-executable instructions stored on a non-transitory computer-readable medium, the method as claimed in claim 1 comprises the steps of:
receiving a third orientation signal, wherein the third orientation signal measures and maintains the orientation of the mobile computing device through the gyroscope;
displaying the third image; and
simultaneously playing the third audio clip with the third image.

11. The method of operating a cheering application with a mobile computing device by executing computer-executable instructions stored on a non-transitory computer-readable medium, the method as claimed in claim 10 comprises:
wherein the third image being a first portion of the default image with the first desired color and the second desired color.

12. The method of operating a cheering application with a mobile computing device by executing computer-executable instructions stored on a non-transitory computer-readable medium, the method as claimed in claim 1 comprises the steps of:
receiving a fourth orientation signal, wherein the fourth orientation signal measures and maintains the orientation of the mobile computing device through the gyroscope;
displaying the fourth image; and
simultaneously playing the fourth audio clip with the fourth image.

13. The method of operating a cheering application with a mobile computing device by executing computer-executable instructions stored on a non-transitory computer-readable medium, the method as claimed in claim 12 comprises:
wherein the fourth image being a second portion of the default image with the first desired color and the second desired color.

14. The method of operating a cheering application with a mobile computing device by executing computer-executable instructions stored on a non-transitory computer-readable medium, the method as claimed in claim 1 comprises the steps of:
providing an information feature of the plurality of preliminary features; and
displaying a plurality of social media icons in order to link with the respective social media networks.
